(19) United States
(12) Patent Application Publication
(10) Pub. No.: US 2025/0183601 A1
(43) Pub. Date: Jun. 5, 2025

(54) RELAY CONNECTOR

(71) Applicant: SUMITOMO WIRING SYSTEMS, LTD., Mie (JP)

(72) Inventor: Takuma WATANABE, Mie (JP)

(21) Appl. No.: 18/840,505

(22) PCT Filed: Feb. 15, 2023
(86) PCT No.: PCT/JP2023/005265

§ 371 Date: Aug. 22, 2024

(30) Foreign Application Priority Data
Feb. 24, 2022 (JP) 2022-026651
Nov. 9, 2022 (JP) 2022-179589

(51) Int. Cl. H01R 13/73; H01R 13/405; H01R 13/504; H01R 13/52

(52) U.S. Cl. CPC H01R 13/73; H01R 13/405; H01R 13/504; H01R 13/5202

(57) ABSTRACT

A housing of a relay connector includes a flange portion to be mounted into an opening of a casing. A sealing member is provided between the opening and the flange portion. The flange portion has a first side surface facing the outside of the casing and a second side surface facing the inside of the casing. The housing includes a first connector fitting portion provided on the first side surface and a second connector fitting portion provided on the second side surface. The flange portion includes a through hole penetrating from a part of the first side surface except the first connector fitting portion to a part of the second side surface except the second connector fitting portion, and a breathable membrane for closing the through hole.

### TECHNICAL FIELD

The present disclosure relates to a relay connector.

### BACKGROUND

For example, Patent Document 1 describes a relay connector to be mounted on a casing of a device. The relay connector is a connector for electrically connecting the inside and outside of the casing of the device. The relay connector is fit into an opening provided in the casing of the device. The relay connector is provided with a sealing member to be interposed between a housing of the relay connector and the opening of the casing. The sealing member seals between the housing of the relay connector and the opening of the casing. The intrusion of water or the like into the inside of the casing through the opening is suppressed by the sealing member.

### PRIOR ART DOCUMENT

### Patent Document

Patent Document 1: JP 2014-135131 A

### SUMMARY OF THE INVENTION

### Problems to be Solved

In the relay connector as described above, an internal pressure of the casing of the device may excessively increase. If no measure is taken for an increase of the internal pressure, the position of the sealing member may be shifted due to a pressure difference between the inside and outside of the casing. If the position of the sealing member is shifted, there is a concern for a reduction in the sealing performance of the sealing member.

The present disclosure aims to provide a relay connector capable of suppressing a reduction in sealing performance.

### Means to Solve the Problem

The present disclosure is directed to a relay connector for electrically connecting inside and outside of a casing by being mounted on the casing of a device, the relay connector being provided with a housing including a flange portion to be mounted into an opening of the casing, a terminal provided to be partially embedded in the housing, and a sealing member for sealing between the opening and the flange portion by being mounted on the flange portion, the flange portion having a first side surface facing the outside of the casing and a second side surface facing the inside of the casing, the housing including a first connector fitting portion provided on the first side surface and a second connector fitting portion provided on the second side surface, and the flange portion including a through hole penetrating from a part of the first side surface except the first connector fitting portion to a part of the second side surface except the second connector fitting portion, and a breathable membrane for closing the through hole.

### Effect of the Invention

A relay connector of the present disclosure exhibits an effect of suppressing a reduction in sealing performance.

### BRIEF DESCRIPTION OF THE DRAWINGS

FIG. 1 is a perspective view of a relay connector of an embodiment.

FIG. 2 is a plan view of the relay connector of the embodiment.

FIG. 3 is a section along 3-3 in FIG. 2.

FIG. 4 is a perspective view of a relay connector of another example.

FIG. 5 is a partial enlarged section of the relay connector of the other example.

FIG. 6 is a section of the relay connector of the other example.

### DETAILED DESCRIPTION TO EXECUTE THE INVENTION

### Description of Embodiments of Present Disclosure

First, embodiments of the present disclosure are listed and described.

[1] The relay connector of the present disclosure is for electrically connecting inside and outside of a casing by being mounted on the casing of a device and provided with a housing including a flange portion to be mounted into an opening of the casing, a terminal provided to be partially embedded in the housing, and a sealing member for sealing between the opening and the flange portion by being mounted on the flange portion, the flange portion having a first side surface facing the outside of the casing and a second side surface facing the inside of the casing, the housing including a first connector fitting portion provided on the first side surface and a second connector fitting portion provided on the second side surface, and the flange portion including a through hole penetrating from a part of the first side surface except the first connector fitting portion to a part of the second side surface except the second connector fitting portion, and a breathable membrane for closing the through hole.

According to this configuration, an air pressure difference between the inside and outside of the casing can be relaxed by a flow of a gas via the through hole and the breathable membrane of the relay connector. In this way, an internal pressure of the casing can be allowed to escape to outside through the through hole and the breathable membrane if the inside of the casing of the device becomes excessively hot. Therefore, a position shift of the sealing member due to an increase in the internal pressure of the casing can be suppressed. As a result, a reduction in the sealing performance of the sealing member can be suppressed. Further, since the relay connector is provided with an adjusting mechanism for adjusting the internal pressure of the casing according to the above configuration, this adjusting mechanism needs not be provided in the casing. As a result, a contribution can be made to an improvement in degree of design freedom on the casing side.

[2] In [1] described above, the inside of the casing may be an oil environment, the outside of the casing may be an air environment, and the breathable membrane may be provided in an end part of the through hole on the first side surface side.

According to this configuration, the breathable film is provided on an external side of the casing, which is the air environment, in the through hole. Thus, the adhesion of oil in the casing to the breathable film can be suppressed.

[3] In [1] or [2] described above, the housing may include a primary molded portion molded with the terminal as an insert and a secondary molded portion molded with the primary molded portion including the terminal as an insert, the primary molded portion may include a primary side flange portion extending to inside of the flange portion, the secondary molded portion may include a covering portion for covering the primary side flange portion, the flange portion may include the primary side flange portion and the covering portion, and the through hole may penetrate through the primary side flange portion and the covering portion.

According to this configuration, the flange portion includes the primary side flange portion and the covering portion of the secondary molded portion. Thus, a sufficient thickness of the entire flange portion can be ensured while the formation of sinks is suppressed by setting each of the primary side flange portion and the covering portion to be thin.

[4] In any one of [1] to [3] described above, the flange portion may include an insertion hole, a fixing bolt to the casing being inserted through the insertion hole.

According to this configuration, the flange portion can be fixed to the casing by the bolt inserted through the insertion hole.

[5] In [4] described above, the flange portion may include a body portion arranged within a range of the opening when viewed from a penetration direction of the through hole, and an outward extending portion extending from a part in a circumferential direction of the body portion and provided with the insertion hole, and a step may be provided between the body portion and the outward extending portion to make the outward extending portion thinner than the body portion.

According to this configuration, the formation of sinks in the body portion can be suppressed by providing the outward extending portion thinner than the body portion, and the rigidity of the outward extending portion can be ensured by ensuring a sufficient thickness of the outward extending portion to be fixed to the casing.

[6] In [5] described above, the step may have an inclined surface for gradually thinning the body portion.

According to this configuration, since the step has the inclined surface for gradually thinning the body portion, it is suppressed that a force is locally applied between the outward extending portion and the body portion with the outward extending portion fixed to the casing and, consequently, breakage is suppressed.

[7] In any one of [1] to [6] described above, the breathable membrane may be a resin porous membrane having waterproofness and breathability.

According to this configuration, the intrusion of water into the inside of the casing through the through hole can be suppressed by the breathable membrane.

[8] In any one of [1] to [7] described above, the flange portion may include a cover member for allowing the through hole to communicate in a direction along the first side surface while covering the through hole on the first side surface side.

According to this configuration, it is suppressed by the cover member that dust and dirt directly deposit on the breathable membrane. That is, in a configuration not including the cover member, the breathability of the breathable membrane may be inhibited by the direct deposit of dust and dirt on the breathable membrane. However, this can be suppressed.

[9] In [8] described above, the flange portion may include a pair of cover restricting pieces bent to bring tips closer to each other while projecting from the first side surface at positions across the through hole, and an engaged portion recessed in the first side surface, and the cover member may include a cover body portion insertable between the pair of cover restricting pieces along the first side surface, and an engaging claw to be fit into the engaged portion.

According to this configuration, the cover member can be easily assembled with the flange portion by being inserted between the pair of cover restricting pieces along the first side surface and fitting the engaging claw into the engaged portion.

### Details of Embodiment of Present Disclosure

A specific example of a relay connector of the present disclosure is described below with reference to the drawings. For the convenience of description, some components may be shown in an exaggerated or simplified manner in each drawing. Further, a dimension ratio of each part may be different in each drawing.

### (Overall Configuration)

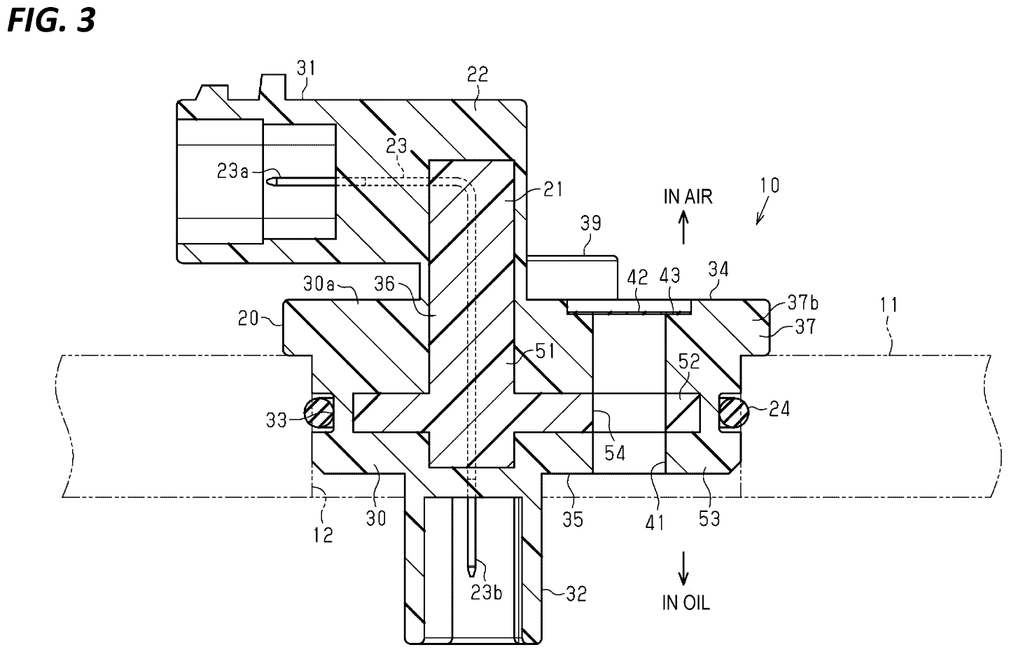

As shown in FIG. 3, a relay connector 10 of this embodiment is mounted on a casing 11 of a device installed in a vehicle. The relay connector 10 is a connector for electrically connecting the inside and outside of the casing 11. The device is, for example, a transmission device. For example, the inside of the casing 11 is an oil environment, and the outside of the casing 11 is an air environment. The relay connector 10 is electrically connected to an unillustrated component inside the casing 11. The casing 11 includes an opening 12, into which the relay connector 10 is mounted. The opening 12 is formed to allow communication between the inside and outside of the casing 11. Note that, in the following description, an internal side of the casing 11 and an external side of the casing 11 may be respectively merely referred to as an “internal side” and an “external side”.

### (Relay Connector 10)

The relay connector 10 is provided with a housing 20, a plurality of terminals 23 and a sealing member 24 for sealing between the housing 20 and the opening 12.

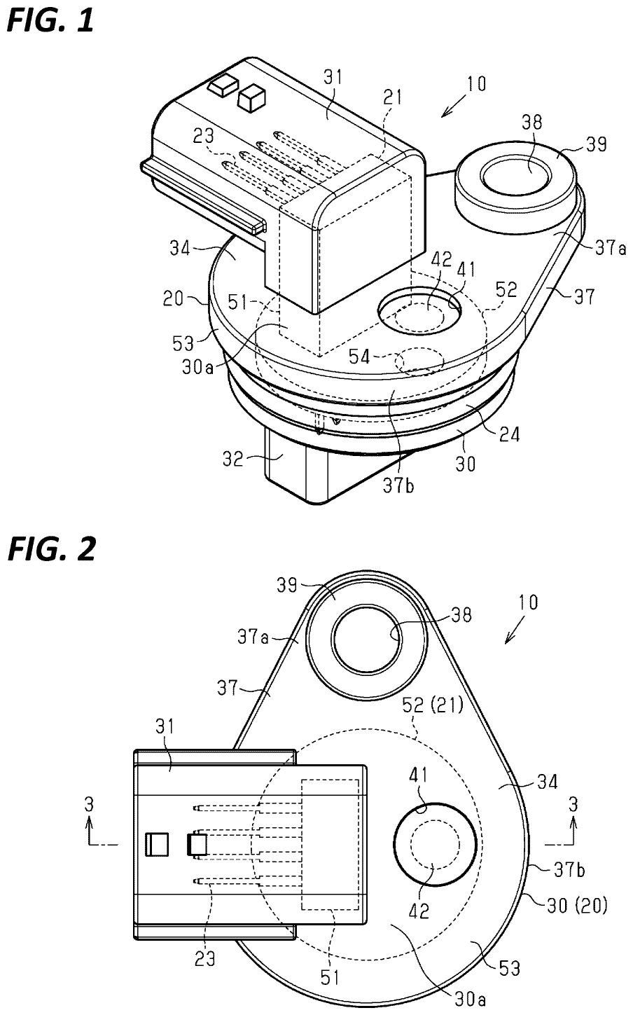

As shown in FIGS. 1, 2 and 3, the housing 20 includes, for example, a primary molded portion 21 and a secondary molded portion 22. The primary molded portion 21 is formed by insert molding with the respective terminals 23 as inserts. The primary molded portion 21 is formed to cover parts of the respective terminals 23. The secondary molded portion 22 is formed by insert molding with the primary molded portion 21 including the respective terminals 23 as an insert. The secondary molded portion 22 is formed to cover the primary molded portion 21. Note that the primary molded portion 21 and the secondary molded portion 22 are, for example, formed of PBT-based resin or the like.

The housing 20 includes a flange portion 30 to be mounted into the opening 12, a first connector fitting portion 31 provided on an external side of the flange portion 30 and a second connector fitting portion 32 provided on an internal side of the flange portion 30.

As shown in FIG. 3, the flange portion 30 is fit in the opening 12. The annular sealing member 24, for example, made of a resilient material such as rubber is provided on the outer peripheral surface of the flange portion 30. The sealing member 24 seals between the flange portion 30 and the opening 12. The sealing member 24 is, for example, mounted in a groove 33 formed along a circumferential direction in the outer peripheral surface of the flange portion 30.

The flange portion 30 has a first side surface 34 facing the outside of the casing 11 and a second side surface 35 facing the inside of the casing 11. The first connector fitting portion 31 extends from the first side surface 34. An unillustrated first mating connector electrically connected to an external device is fit into the first connector fitting portion 31. The second connector fitting portion 32 extends from the second side surface 35. An unillustrated second mating connector electrically connected to a component in the casing 11 is fit into the second connector fitting portion 32.

A part of the terminal 23 is embedded in the housing 20. One end part 23a of the terminal 23 extends to the first connector fitting portion 31. Another end part 23b of the terminal 23 extends to the second connector fitting portion 32. The terminal 23 electrically connects the first mating connector fit in the first connector fitting portion 31 and the second mating connector fit in the second connector fitting portion 32. Note that the first connector fitting portion 31 is bent in a direction along the first side surface 34. That is, a side surface of the first connector fitting portion 31 is facing the first side surface 34. Further, a fitting direction of the first mating connector into the first connector fitting portion 31 is a direction along the first side surface 34.

The housing 20 includes a terminal holding portion 36 for holding the terminals 23. The first connector fitting portion 31 is provided on one end side of the terminal holding portion 36, and the second connector fitting portion 32 is provided on the other end side of the terminal holding portion 36. The flange portion 30 extends in a flange-like manner from the terminal holding portion 36. Further, the flange portion 30 includes a contact portion 37 for coming into contact with the outer side surface of the casing 11. In particular, the flange portion 30 includes a body portion 30a to be arranged within a range of the opening 12 when viewed from a penetration direction of a through hole 41 and the contact portion 37 extending in a flange-like manner from the body portion 30a and configured to come into contact with the outer side surface of the casing 11. The contact portion 37 includes an outward extending portion 37a extending long from one part in the circumferential direction of the body portion 30a and a brim portion 37b extending short from the entire body portion 30a except a part in the circumferential direction where the outward extending portion 37a is provided.

As shown in FIG. 1, the contact portion 37 of the flange portion 30 includes an insertion hole 38. In particular, the outward extending portion 37a includes the insertion hole 38. The insertion hole 38 is constituted by a hole of a hollow cylindrical collar 39 partially embedded in the flange portion 30. The collar 39 is, for example, made of metal. An unillustrated fixing bolt is inserted through the insertion hole 38. The flange portion 30 is fixed to the casing 11 by tightening the bolt.

As shown in FIG. 3, the flange portion 30 includes the through hole 41 and a breathable membrane 42 for closing the through hole 41. The through hole 41 penetrates through the flange portion 30 from the first side surface 34 to the second side surface 35. The through hole 41 is provided at a position different from the first and second connector fitting portions 31, 32. That is, an external side end part of the through hole 41 is provided at a position different from a position in the first side surface 34 where the first connector fitting portion 31 is provided. Further, an internal side end part of the through hole 41 is provided at a position different from a position in the second side surface 35 where the second connector fitting portion 32 is provided.

The breathable membrane 42 is, for example, a resin porous membrane having waterproofness and breathability. That is, the breathable membrane 42 has a property of not allowing the permeation of a liquid while allowing the permeation of a gas. The breathable membrane 42 is, for example, made of PTFE resin or the like.

The breathable membrane 42 is provided in an end part of the through hole 41 on the side of the first side surface 34. A fixing surface 43, to which the breathable membrane 42 is fixed, is formed in the end part of the through hole 41 on the side of the first side surface 34. The fixing surface 43 is arranged at a position closer to the first side surface 34 than to the second side surface 35 between the first and second side surfaces 34, 35. The fixing surface 43 has an annular shape when viewed from the penetration direction of the through hole 41. The breathable membrane 42 is, for example, welded to the fixing surface 43.

The primary molded portion 21 constituting the housing 20 includes a terminal covering portion 51 for covering parts of the terminals 23 and a primary side flange portion 52 extending in a flange-like manner into the inside of the flange portion 30 from the terminal covering portion 51. The terminal covering portion 51 forms a part of the terminal holding portion 36. The secondary molded portion 22 includes a covering portion 53 for covering the primary side flange portion 52. The flange portion 30 is configured to include the primary side flange portion 52 and the covering portion 53. The covering portion 53 forms the outer contour of the flange portion 30. The through hole 41 penetrates through the primary side flange portion 52 and the covering portion 53. That is, the primary side flange portion 52 of the primary molded portion 21 includes a through hole 54 forming a part of the through hole 41.

Functions of this embodiment are described.

(1) The flange portion 30 includes the through hole 41 penetrating from the part in the first side surface 34 except the first connector fitting portion 31 to the part in the second side surface 35 except the second connector fitting portion 32, and the breathable membrane 42 for closing the through hole 41. According to this configuration, an air pressure difference between the inside and outside of the casing 11 can be relaxed by a flow of a gas via the through hole 41 and the breathable membrane 42 of the relay connector 10. In this way, the internal pressure of the casing 11 can be allowed to escape to outside through the through hole 41 and the breathable membrane 42 if the inside of the casing 11 of the device becomes excessively hot. Therefore, a position shift of the sealing member 24 due to an increase in the internal pressure of the casing 11 can be suppressed. As a result, a reduction in the sealing performance of the sealing member 24 can be suppressed. Further, since the relay connector 10 is provided with an adjusting mechanism for adjusting the internal pressure of the casing 11 according to the above configuration, this adjusting mechanism needs not be provided in the casing 11. As a result, a contribution can be made to an improvement in degree of design freedom on the side of the casing 11.

Further, the through hole 41 is closed by the breathable membrane 42. Thus, the outflow of oil inside the casing 11 to the outside through the through hole 41 can be suppressed by the breathable membrane 42. Further, the through hole 41 is provided at the position different from the first and second connector fitting portions 31, 32. Since the first connector fitting portion 31 including the terminals 23 and the second connector fitting portion 32 have relatively many design restrictions and the like, a contribution can be made to an improvement in degree of design freedom by avoiding the first and second connector fitting portions 31, 32 as the setting position of the through hole 41.

Further, if a ventilation hole is set in the first connector fitting portion 31, the oil may adhere to the inside of the first mating connector fit in the first connector fitting portion 31 if the oil inside the casing 11 flows out to the first connector fitting portion 31 through this ventilation hole. In that respect, the adhesion of the oil to the inside of the first mating connector can be suppressed by providing the through hole 41 at the position different from the first connector fitting portion 31.

(2) The inside of the casing 11 is an oil environment. Further, the outside of the casing 11 is an air environment. The breathable membrane 42 is provided in the end part of the through hole 41 on the side of the first side surface 34. According to this configuration, the breathable membrane 42 is provided on the external side of the casing 11, which is the air environment, in the through hole 41. Thus, the adhesion of the oil in the casing 11 to the breathable membrane 42 can be suppressed.

(3) The housing 20 includes the primary molded portion 21 molded with the terminals 23 as inserts and the secondary molded portions 22 molded as the primary molded portion 21 including the terminals 23 as an insert. The primary molded portion 21 includes the primary side flange portion 52 extending to the inside of the flange portion 30. The secondary molded portion 22 includes the covering portion 53 for covering the primary side flange portion 52. The flange portion 30 includes the primary side flange portion 52 and the covering portion 53, and the through hole 41 penetrates through the primary side flange portion 52 and the covering portion 53. According to this configuration, the flange portion 30 includes the primary side flange portion 52 and the covering portion 53 of the secondary molded portion 22. Thus, a sufficient thickness of the entire flange portion 30 can be ensured while the formation of sinks is suppressed by setting each of the primary side flange portion 52 and the covering portion 53 to be thin.

(4) The flange portion 30 includes the insertion hole 38, through which the fixing bolt to the casing 11 is inserted. According to this configuration, the flange portion 30 can be fixed to the casing 11 by the bolt inserted through the insertion hole 38.

(5) The breathable membrane 42 is a resin porous membrane having waterproofness and breathability. According to this configuration, the intrusion of water into the inside of the casing 11 through the through hole 41 can be suppressed by the breathable membrane 42.

### <Modifications>

This embodiment can be modified and carried out as follows. This embodiment and the following modifications can be carried out in combination without technically contradicting each other.
Although the first side surface 34 of the flange portion 30 is described as a flat surface in the above embodiment, there is no limitation to this and the first side surface 34 may have a step.

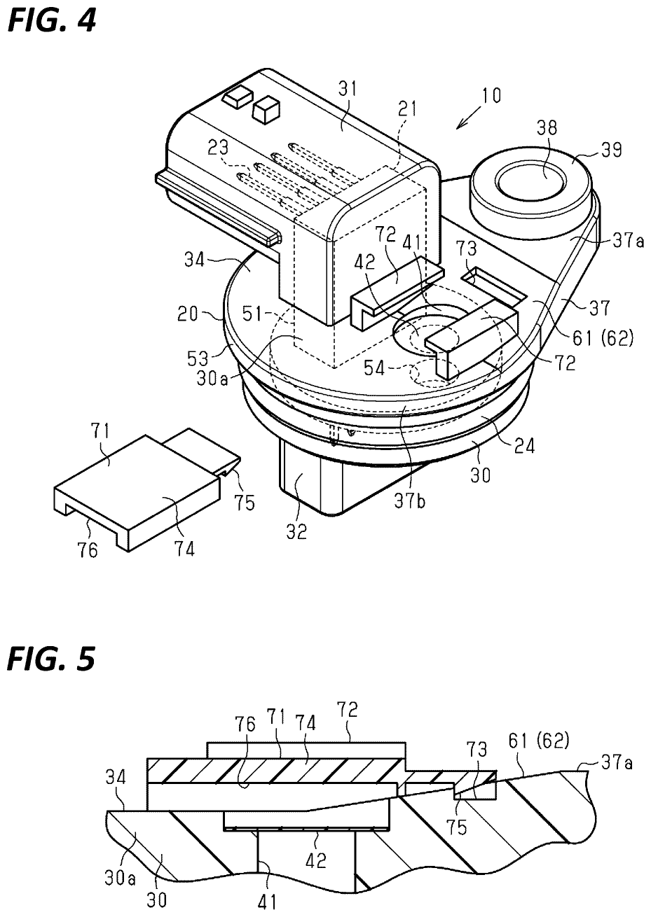

For example, as shown in FIGS. 4 and 5, a step 61 may be provided to make the outward extending portion 37a thinner than the body portion 30a between the body portion 30a and the outward extending portion 37a in the flange portion 30. The step 61 in this example has an inclined surface 62 for gradually thinning the body portion 30a.

By doing so, the formation of sinks in the body portion 30a can be suppressed by thinning the body portion 30a, and the rigidity of the outward extending portion 37a can be ensured by ensuring a sufficient thickness of the outward extending portion 37a to be fixed to the casing 11. Further, since the step 61 has the inclined surface 62 for gradually thinning the body portion 30a, it is suppressed that a force is locally applied between the outward extending portion 37a and the body portion 30a with the outward extending portion 37a fixed to the casing 11 and, consequently, breakage is suppressed.

Note that the step 61 may have a step surface perpendicular to the first side surface 34, rather than the inclined surface 62.
Although the breathable membrane 42 is exposed on the external side along the penetration direction of the through hole 41 in the above embodiment, there is no limitation to this and the breathable membrane 42 may not be exposed to the external side while the breathability of the breathable membrane 42 is maintained.

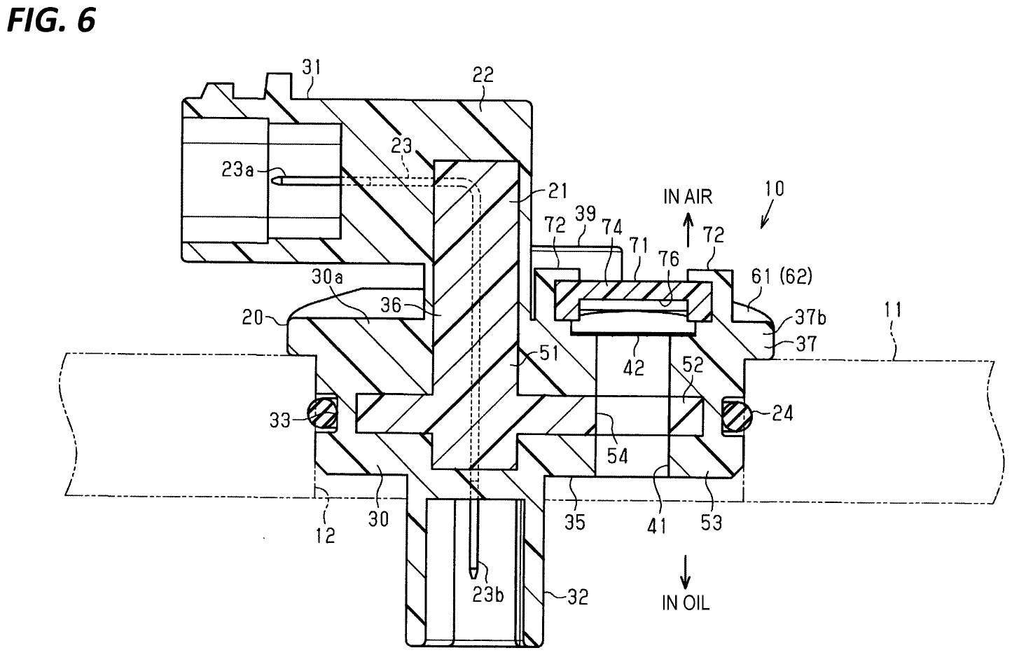

For example, as shown in FIGS. 4 to 6, the flange portion 30 may include a cover member 71 for allowing the through hole 41 to communicate in a direction along the first side surface 34 while covering the through hole 41 on the side of the first side surface 34.

In particular, the flange portion 30 includes a pair of cover restricting pieces 72 bent to bright tips closer to each other while projecting from the first side surface 34 at positions across the through hole 41, and an engaged portion 73 recessed in the first side surface 34. The engaged portion 73 of this example is provided in the inclined surface 62.

The cover member 71 includes a cover body portion 74 insertable between the pair of cover restricting pieces 72 along the first side surface 34, and an engaging claw 75 to be fit into the engaged portion 73. The engaging claw 75 is provided to project from an end part of the cover body portion 74 in an insertion direction, in which the cover body portion 74 is inserted between the pair of cover restricting pieces 72. Further, the cover body portion 74 includes a recess 76 extending in a direction opposite to the insertion direction described above from a position facing the through hole 41. The recess 76 allows communication between the through hole 41 and outside in the direction along the first side surface 34.

By doing so, it is suppressed by the cover member 71 that dust and dirt directly deposit on the breathable membrane 42. That is, in a configuration not including the cover member 71, the breathability of the breathable membrane 42 may be inhibited by the direct deposit of dust and dirt on the breathable membrane 42. However, this can be suppressed.

Further, according to the above configuration, the cover member 71 can be easily assembled with the flange portion 30 by being inserted between the pair of cover restricting pieces 72 along the first side surface 34 and fitting the engaging claw 75 into the engaged portion 73.

Note that the cover member 71 and a structure for fixing the cover member 71 to the flange portion 30 may be changed to other structures. For example, the flange portion 30 may not include the cover restricting pieces 72 and the engaged portion 73, and a cover member may be fixed to the flange portion by an adhesive.
The housing 20 of the above embodiment includes the primary molded portion 21 and the secondary molded portion 22. However, instead of this, the housing 20 may be, for example, constituted only by the primary molded portion.
A fixing mode of the breathable membrane 42 to the through hole 41 is not limited to the one of the above embodiment, and the breathable membrane 42 may be, for example, fixed by an adhesive.
The configurations such as shapes of the first and second connector fitting portions 31, 32 are not limited to those of the above embodiment and can be changed as appropriate according to the configuration.
The breathable membrane 42 of the above embodiment is provided in the end part of the through hole 41 on the side of the first side surface 34. However, instead of this, the breathable membrane 42 may be provided in a central part of the through hole 41 in the penetration direction or an end part of the through hole 41 on the side of the second side surface 35.
Although being embodied as the relay connector 10 to be mounted on the transmission device in the above embodiment, the present invention may be applied to a relay connector to be mounted on a device other than the transmission device. Note that an environment inside a casing of a device on which the relay connector 10 is mounted is not limited to an oil environment and the present invention is also applicable to a relay connector of a device, in a casing of which oil is not used.
The embodiment and modifications disclosed this time are illustrative in all aspects, and the present invention is not limited to these illustrations. That is, the scope of the present invention is represented by claims and intended to include all changes in the scope of claims and in the meaning and scope of equivalents.

### LIST OF REFERENCE NUMERALS

10 relay connector
11 casing
12 opening
20 housing
21 primary molded portion
22 secondary molded portion
23 terminal
23a one end part
23b other end part
24 sealing member
30 flange portion
30a body portion
31 first connector fitting portion
32 second connector fitting portion
33 groove
34 first side surface
35 second side surface
36 terminal holding portion
37 contact portion
37a outward extending portion
37b brim portion
38 insertion hole
39 collar
41 through hole
42 breathable membrane
43 fixing surface
51 terminal covering portion
52 primary side flange portion
53 covering portion
54 through hole
61 step
62 inclined surface
71 cover member
72 cover restricting piece
73 engaged portion
74 cover body portion
75 engaging claw
76 recess

1. A relay connector for electrically connecting inside and outside of a casing by being mounted on the casing of a device, comprising:
a housing including a flange portion to be mounted into an opening of the casing;
a terminal provided to be partially embedded in the housing; and
a sealing member for sealing between the opening and the flange portion by being mounted on the flange portion,
the flange portion having a first side surface facing the outside of the casing and a second side surface facing the inside of the casing,
the housing including a first connector fitting portion provided on the first side surface and a second connector fitting portion provided on the second side surface, and
the flange portion including a through hole penetrating from a part of the first side surface except the first connector fitting portion to a part of the second side surface except the second connector fitting portion and a breathable membrane for closing the through hole.

2. The relay connector of claim 1, wherein:
the inside of the casing is an oil environment,
the outside of the casing is an air environment, and
the breathable membrane is provided in an end part of the through hole on the first side surface side.

3. The relay connector of claim 1, wherein:
the housing includes a primary molded portion molded with the terminal as an insert and a secondary molded portion molded with the primary molded portion including the terminal as an insert,
the primary molded portion includes a primary side flange portion extending to inside of the flange portion,
the secondary molded portion includes a covering portion for covering the primary side flange portion,
the flange portion includes the primary side flange portion and the covering portion, and
the through hole penetrates through the primary side flange portion and the covering portion.

4. The relay connector of claim 1, wherein the flange portion includes an insertion hole, a fixing bolt to the casing being inserted through the insertion hole.

5. The relay connector of claim 4, wherein:
the flange portion includes a body portion arranged within a range of the opening when viewed from a penetration direction of the through hole, and an outward extending portion extending from a part in a circumferential direction of the body portion and provided with the insertion hole, and
a step is provided between the body portion and the outward extending portion to make the outward extending portion thinner than the body portion.

6. The relay connector of claim 5, wherein the step has an inclined surface for gradually thinning the body portion.

7. The relay connector of claim 1, wherein the breathable membrane is a resin porous membrane having waterproofness and breathability.

8. The relay connector of claim 1, wherein the flange portion includes a cover member for allowing the through hole to communicate in a direction along the first side surface while covering the through hole on the first side surface side.

9. The relay connector of claim 8, wherein:
the flange portion includes a pair of cover restricting pieces bent to bring tips closer to each other while projecting from the first side surface at positions across the through hole, and an engaged portion recessed in the first side surface, and
the cover member includes a cover body portion insertable between the pair of cover restricting pieces along the first side surface, and an engaging claw to be fit into the engaged portion.
